(19) United States
(12) Patent Application Publication
(10) Pub. No.: US 2021/0287830 A1
(43) Pub. Date: Sep. 16, 2021

(54) SURGE ARRESTER, AND MANUFACTURING PROCESS FOR A SURGE ARRESTER

(71) Applicant: SIEMENS AKTIENGESELLSCHAFT, MUENCHEN (DE)

(72) Inventor: ERHARD PIPPERT, DALLGOW-DOEBERITZ OT SEEBURG (DE)

(21) Appl. No.: 16/490,089

(22) PCT Filed: Feb. 27, 2018
(86) PCT No.: PCT/EP2018/054737

§ 371 Date: Aug. 30, 2019

(30) Foreign Application Priority Data
Mar. 7, 2017 (DE) 10 2017 203 657.5

(51) Int. Cl. H01C 7/12; H01T 1/15; H01T 4/04

(52) U.S. Cl. CPC H01C 7/126; H01T 4/04; H01T 1/15

(57) ABSTRACT

A surge arrester includes a fluid-tight housing and a pressure relief assembly constructed to provide a fluid-conducting connection to the outside of the housing if a gas pressure inside the housing exceeds a threshold value. The pressure relief assembly is secured to the housing by at least one twist lock or lockable rotary closure. A corresponding manufacturing process for a surge arrester is also provided.

The invention relates to a surge arrester according to the preamble of claim 1 and a manufacturing process according to the preamble of claim 11.

Surge arresters are used in the moderate-voltage and high-voltage range to dissipate so-called surges, i.e., voltages well above the rated voltages provided in operation, safely to ground. In this way, damage to equipment such as transformers, for example, is avoided. For example, a surge arrester for high voltage can be arranged on an overhead line and can dissipate impermissibly high currents to ground in the event of lightning strike or short-circuit.

Surge arresters generally contain so-called varistors, i.e., electrical resistors, the electrical resistance value of which is very high up to a design-related threshold voltage and is greatly reduced above the threshold voltage, so that the surge arrester becomes a good electrical conductor. For example, metal oxide resistors in disk shape are arranged one over another in a housing and are connected at the respective ends of the housing to the high-voltage potential and the ground potential. In this case, the surge arrester is generally hardly conductive in regular operation, so that only a minor leakage current flows to ground. In contrast, in case of fault, a high leakage current flows. So-called encapsulated surge arresters are frequently used for the high-voltage usage, which comprise a grounded and fluid-tight housing, which is filled with an electrically insulating protective gas, for example, sulfur hexafluoride (SF6). In the event of a strong electrical strain of the surge arrester, damage with strong expansion of gas can occur in the interior of the housing. To avoid endangering people and machines in the surroundings of the surge arrester due to uncontrolled bursting of the arrester, pressure relief devices are provided.

A surge arrester filled with a protective gas for high voltage, which is equipped with a pressure relief assembly for the case of fault, is known from the document WO 2013/167445 A1. In this case, an overpressure in the interior of the housing of the arrester can be dissipated by tearing of a membrane made of metal. The escaping gas flow encounters a cavity between the membrane and a deflection cover, which discharges the gas laterally in relation to a longitudinal axis through the arrester. A blowout chute is arranged on the deflection cover, which ensures a controlled outflow of the gas flow into the surroundings. Furthermore, the deflection cover bulges toward the membrane in such a way that it can yield slightly in case of fault and can absorb a part of the kinetic energy of the outflowing gas by plastic deformation away from the membrane. A certain cushion effect results. The membrane is secured by a clamping ring on a flange of the surge arrester and is screwed on using numerous screws.

Proceeding from the known surge arrester, the invention has the object of specifying a surge arrester which is producible comparatively simply and cost-effectively.

The invention achieves this object by way of a surge arrester as claimed in claim 1.

The assembly of screw connections for securing the membrane in previous surge arresters has been performed manually by an assembly worker, because presently assembly machines such as manufacturing robots, for example, are not capable of positioning the numerous comparatively small screws correctly at the respective thread and screwing them as intended into the flange. It is a significant advantage of the invention that these screw connections can be dispensed with entirely. Rather, both the membrane and also the cover and/or closure part can be secured according to the invention by a single rotational movement. This step can readily be carried out rapidly and reliably by an assembly machine, which saves time and personnel in the manufacturing and thus in particular saves costs. Significantly fewer components are required for the assembly than in previous surge arresters, which is simple and saves costs.

In one preferred embodiment of the surge arrester according to the invention, the lockable rotary closure comprises multiple locking projections, which are secured by rotating in complementary recesses of the housing. For example, at least three locking projections can each be arranged at equal angle intervals in relation to one another on an outer contour of the pressure relief assembly. For example, three locking projections can particularly preferably be provided, which are each formed as a strip-type projection and extend approximately 60° along the outer contour. In this case, approximately 60° of the outer contour remains unoccupied by the locking projections, so that the complementary regions of the housing can engage in these unoccupied regions. By rotating the rotary closure, the complementary regions come to rest on the locking projections in such a way that the pressure relief assembly is pressed onto the housing. If one locking projection is used in each case, which a complementary region of the housing engages behind and presses on, the term single bayonet fitting is used in technology for this variant.

In one particularly preferred embodiment of the surge arrester according to the invention, each two locking projections are arranged in pairs in such a way that a double bayonet fitting is formed. This is advantageous because the contact pressure effect is increased in this way in relation to a single bayonet fitting. A formation of the rotary closure having catch projections which are arranged in groups, i.e., having more than two catch projections per group, is also advantageous.

In a further preferred embodiment of the surge arrester according to the invention, the pressure relief assembly comprises an essentially cup-shaped locking means having a base and a side wall. This embodiment is advantageous because the cup is particularly suitable for collecting and deflecting escaping gas.

In one particularly preferred embodiment of the surge arrester according to the invention, essentially an entire height of the side wall of the locking means is provided with locking projections. This is advantageous because a particularly strong contact pressure force is exerted by the interlocking of the numerous locking projections with the complementary regions of the housing.

In a further preferred embodiment of the surge arrester according to the invention, the locking means comprises multiple support ribs, which are arranged along the inner side of the side wall facing toward the cup interior. In this case, the support ribs extend from the side wall of the cup to the base. This is advantageous because the support ribs on the cup-shaped locking means ensure the mechanical stability of the pressure relief device even with comparatively low wall thicknesses for the side wall and the base. Moreover, the support ribs ensure a stable support for a second contact pressure means, so that a sufficiently large (for example, ring-shaped) area is provided for pressing on a membrane.

In a further preferred embodiment of the surge arrester according to the invention, the side wall comprises a first outflow opening, which is designed to have a fluid-conducting connection to a second outflow opening in the housing in the assembled state, so that, if a fluid flows out of the interior of the housing, a deflection of the fluid flow out of the cup-shaped locking means through both outflow openings takes place. This is advantageous because an efficient deflection of an escaping gas flow from the direction of a longitudinal axis through the surge arrester in a lateral direction is possible. The cup-shaped locking means receives gas from the interior, for example, in the event of tearing of a membrane, and can thus somewhat reduce a first overpressure before the gas flows through the two outflow openings, for example into a blowout chute which is typical in surge arresters. This embodiment is particularly advantageous because the locking means provides, on the one hand, a deflection function for outflowing gas and, on the other hand, a closure system. The assembly is particularly simplified by the combination of these two functions in one component.

In a further preferred embodiment of the surge arrester according to the invention, at least three locking projections are provided, which are arranged along the outer side of the side wall facing away from the cup interior.

In a further preferred embodiment of the surge arrester according to the invention, the base bulges out toward the cup interior. This is advantageous because due to the bulging of the base, a contour which is essentially curved in cross section results. Such a bulge having curved cross section can more easily absorb acting forces and is therefore more stable than a flat base.

In a further preferred embodiment of the surge arrester according to the invention, the pressure relief assembly is arranged at one end of the surge arrester and comprises a membrane which is designed to tear if the threshold value for the gas pressure is exceeded.

In a further preferred embodiment of the surge arrester according to the invention, the membrane is laid on the surge arrester side on a first contact pressure means and is secured on the side facing away from the surge arrester by a second contact pressure means. This is advantageous because the tear-sensitive membrane can be fixedly clamped in this way. For example, both contact pressure means can be formed as metal disks having the same diameter as the membrane, wherein the metal disks each comprise at least one opening. The pressure can be applied to the membrane through the openings or the gas can flow through the openings if the membrane tears, respectively. The openings are preferably each provided as a large circular opening, so that the respective contact pressure means is essentially formed as a ring made of a metal plate.

In a further preferred embodiment of the surge arrester according to the invention, the pressure relief device comprises an assembly projection for transmitting a rotational movement on the side of the base facing away from the cup interior. The assembly projection is used for the purpose of engaging using a machine on the assembly projection during automated assembly and rotating the locking means and/or the cup. Multiple assembly projections and/or “closure lugs” can also be provided on the base of the cup.

Furthermore, proceeding from manual manufacturing processes for known surge arresters, the invention has the object of specifying a manufacturing process for a surge arrester which can be carried out comparatively simply and cost-effectively.

The invention achieves this object by way of a manufacturing process as claimed in claim 11. Preferred embodiments are described in dependent claims 12 and 13. The same advantages result accordingly as explained at the outset for the surge arrester according to the invention.

For better explanation of the invention, a preferred and advantageous embodiment of the surge arrester according to the invention is explained hereafter in greater detail on the basis of three figures. In the figures:

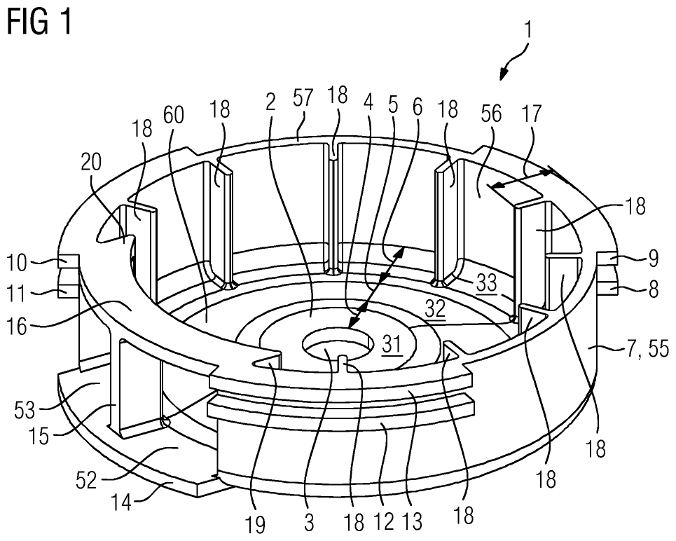

FIG. 1 shows a locking means according to the invention,

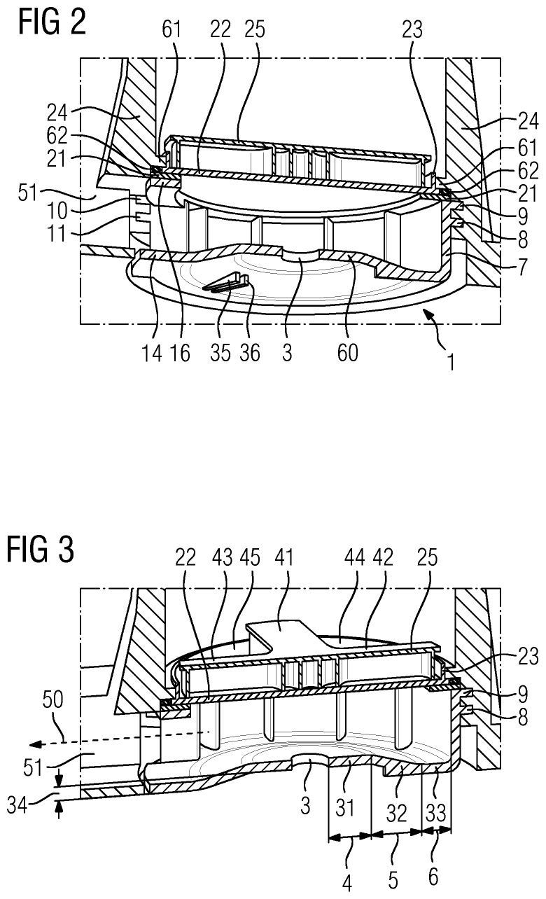

FIG. 2 shows a cross section through a surge arrester having a pressure relief assembly according to the invention, and

FIG. 3 shows a further cross section through the surge arrester having the pressure relief assembly according to the invention.

FIG. 1 shows a locking means 1, which is formed essentially cup-shaped. A side wall 7 in the form of a cylindrical jacket comprises an outer side 55 and an inner side 56. A base 60 comprises a base inner side 2, which is oriented toward the cup interior. A test opening 3 is located in the center of the base 60. The test opening 3 is used for test purposes in order to check a fluid-tightness in the assembled state on the surge arrester. Before use of the surge arrester, the test opening 3 is closed by a plug (not shown). The base 60 bulges toward the cup interior and in this way forms three regions 31, 32, 33, which are each formed ring-shaped and have the widths 4, 5, 6. Support ribs 18 are provided in the cup interior, which are attached to the side wall 7, on the one hand, and to the base 60, on the other hand. The support ribs 18 form a disk-type terminus on the open side of the cup together with an upper edge 57 of the side wall 7, which terminus is suitable for also contacting the support ribs 18 by applying a contact pressure means (not shown) to the upper side wall 57. In this manner, the support ribs 18 and also the upper side wall 57 as contact regions transmit mechanical forces to the cup base 60, which relieves the side wall 7. The support ribs 18 thus enhance the mechanical stability of the locking means 1.

The locking means 1 comprises locking projections 8, 9, 10, 11, 12, 13 on the outer side 55 of the side wall 7. The locking projections 8-13 form a double bayonet fitting, which can be secured by rotation in complementary recesses of a housing (not shown). The locking projections 8-13 are arranged in pairs in such a way that approximately 60° of the outer wall, i.e., approximately ⅙ of the circumference of the side wall, remains free of the locking projections on the outer side 55 of the side wall 7 in each case. Due to these free regions, the locking means 1 can be inserted into a housing and secured by rotation. The locking means arranged in pairs each comprise a locking means 9, 10, 13, which is arranged directly at the upper edge 57 of the side wall 7. In this way, the locking means 9, 10, 13 additionally widen the upper edge 57 of the side wall 7 and offer, like the cooling ribs 18, a larger contact surface for a contact pressure means (not shown). The mechanical stability is also improved in this way.

Two openings 52, 53 are provided in the side wall 7, which together form a first outflow opening 52, 53 of the locking means 1. To improve the mechanical stability of the outflow openings 52, 53, the upper edge 57 of the side wall 7 is formed as a widened edge 16 in the region of the outflow openings 52, 53. The widened edge 16 comprises two protrusions 19, 20 toward the cup interior. The protrusions 19, 20 are used, similarly to the support ribs 18, for improving the mechanical stability when applying a contact pressure means (not shown).

The widened upper edge 16 is supported via a connecting part 15 on a widened base part 14. The widened base part 14 protrudes here in the same manner as the catch projections 8-13 somewhat beyond the outer wall 55 of the side wall 7, to be locked in a housing (not shown).

FIG. 2 shows in cross section how the locking means 1 together with a first contact pressure means 25, a membrane 22, 23, and a second contact pressure means 21 form a pressure relief assembly 1, 21, 22, 23, 25, which is secured by rotation in a housing 24. It is recognizable that the interior of the cup is open to the left in the direction of a second outflow opening 51 in the housing, since the first outflow opening 52, 53 and the second outflow opening 51 are brought into congruence. For the machine execution of a rotational movement, two assembly projections 35, 36 are provided on the lower side of the base 60. A ring-shaped second contact pressure means 21, which is mechanically supported by the mentioned elements 18, 9, 10, 16, is applied to the support ribs 18 and the locking means 9, 10 and also to the widened upper edge 16 and the upper side wall 57. A membrane 22, which comprises an outer edge 23 in the form of a cylindrical jacket, formed as a thin metal plate is applied to the second contact pressure means 21. The outer edge 23 is applied to the membrane 22 toward the interior of the housing 24 and thus facing away from the second contact pressure means 21. The membrane 22 is thus not supported over a large part of the cavity, which the locking means 21 provides by way of its cup-shaped formation. A seal ring 62 is arranged on the second contact pressure means 21 and enclosing the membrane 22. The seal ring 62, the membrane 22, and the membrane section 23 in the form of a cylindrical jacket form a ring-shaped peripheral recess, in which a protrusion 61, which is also ring-shaped and peripheral, of the housing 24 engages. This design is suitable for pressing the membrane 22, 23 and the seal ring 62 against the housing and securing them in a fluid-tight manner upon securing of the locking means 1 by means of the locking projections 8, 9, 10, 11 via the second contact pressure means 21. A first contact pressure means 25 is provided on the membrane 22 and enclosed by the cylindrical peripheral membrane portion 23.

FIG. 3 shows another cross-sectional view of the housing having the pressure relief assembly. It can be seen that the base 60 has a thickness 34. Three regions 31, 32, 33 result due to the bulge of the base. The first base region 31 is arranged as a concentric ring around the test opening 3 and is arranged essentially parallel to the membrane surface 22. The bulge is produced in a beveled base region 32. The base is in turn supported by the support ribs 18 and attached to the side wall in a third base region 33. The first base region 31 has a width 4. The second base region 32 has a width 5. The third base region 33 has a width 6. The path which a fluid takes when flowing out of the cup interior outward in the direction of a blowout chute if the membrane 22, 23 tears is indicated by an arrow 50.

The first contact pressure means 25 is formed essentially cross-shaped and comprises four wing sections, of which three wing sections 41, 42, 43 are recognizable. Open regions 43, 44, in which the interior of the housing or the fluid-tight gas chamber, respectively, directly encounters the membrane 22, are located between the wing sections 41, 42, 43. This is advantageous because if an overpressure arises in the interior of the surge arrester or the housing 24, respectively, the gas pressure on the regions 43, 44 may cause the membrane 22 to bulge toward the interior of the cup-shaped locking means 1 and finally tear. If the membrane tears, the gas can thus flow into the cavity of the cup, whereby a first overpressure is slightly reduced. The bulge of the base 60 effectuates improved mechanical stability. Finally, the gas flow is laterally deflected and discharged in the direction of the arrow 50 through the first and the second outflow opening 51, 52, 53 to a blowout chute (not shown) of the surge arrester.

1-13. (canceled)

14. A surge arrester, comprising:
a fluid-tight housing having an outside;
a pressure relief assembly configured to provide a fluid-conducting connection to said outside of the housing if a gas pressure inside said housing exceeds a threshold value; and
at least one lockable rotary closure securing said pressure relief assembly to said housing.

15. The surge arrester according to claim 14, wherein said lockable rotary closure includes a plurality of locking projections being secured by rotating in complementary recesses of said housing.

16. The surge arrester according to claim 14, wherein said pressure relief assembly includes a substantially cup-shaped locking device having a base and a side wall.

17. The surge arrester according to claim 16, wherein:
said cup-shaped locking device has a cup interior;
said side wall has an inner side facing toward said cup interior; and
said locking device includes a plurality of support ribs disposed along said inner side.

18. The surge arrester according to claim 16, wherein said housing has an interior, and said side wall includes a first outflow opening connected in a fluid-conducting manner to a second outflow opening in said housing in an assembled state, causing a deflection of a fluid flow out of said cup-shaped locking device through said first and second outflow openings to take place if a fluid flows out of said interior of said housing.

19. The surge arrester according to claim 16, wherein:
said cup-shaped locking device has a cup interior;
said side wall has an outer side facing away from said cup interior; and
said lockable rotary closure includes at least three locking projections disposed along said outer side.

20. The surge arrester according to claim 16, wherein said cup-shaped locking device has a cup interior, and said base bulges toward said cup interior.

21. The surge arrester according to claim 14, which further comprises:
ends of the surge arrester;
said pressure relief assembly being disposed at one of said ends of the surge arrester; and
said pressure relief assembly including a membrane constructed to tear if the threshold value for the gas pressure is exceeded.

22. The surge arrester according to claim 21, which further comprises:
first and second contact pressure devices;
said membrane having a side facing towards the surge arrester being laid on said first contact pressure device; and
said membrane having a side facing away from the surge arrester being secured by said second contact pressure device.

23. The surge arrester according to claim 20, wherein said pressure relief device includes an assembly projection on a side of said base facing away from said cup interior for transmitting a rotational movement.

24. A process for manufacturing a surge arrester, the process comprising the following steps:
placing a membrane on a fluid-tight housing;
placing a pressure relief assembly having at least one lockable rotary closure on the housing;
locking the rotary closure on the housing while securing the membrane; and
using the pressure relief assembly to provide a fluid-conducting connection to an outside of the housing if a gas pressure inside the housing exceeds a threshold value.

25. The manufacturing process according to claim 24, which further comprises placing the membrane between first and second contact pressure devices by placing the first contact pressure device on a side of the membrane facing toward the surge arrester and placing the second contact pressure device on a side of the membrane facing away from the surge arrester.

26. The manufacturing process according to claim 24, which further comprises:
forming the pressure relief device as a substantially cup-shaped locking device having a base and a side wall;
locking the locking device on the housing by exerting an assembly machine force on an assembly projection on a side of the base facing away from a cup interior of the locking device; and
securing the locking device on the housing by rotating.
